(19) United States
(12) Patent Application Publication
(10) Pub. No.: US 2007/0110553 A1
(43) Pub. Date: May 17, 2007

(54) Hydraulic grapple apparatus and method for use of same

(76) Inventors: John Chris Neal, Canton, TX (US); John Mark Houser, Canton, TX (US); John E. Norman, Canton, TX (US)

Correspondence Address: SCOTT T. GRIGGS, 901 MAIN STREET, SUITE 6300, DALLAS, TX, 75202, US

(21) Appl. No.: 11/273,451

(22) Filed: Nov. 14, 2005

(51) Int. Cl. B66C 1/00

(52) U.S. Cl. 414/741

(57) ABSTRACT

A hydraulic grapple apparatus and method for use of the same are disclosed. In one embodiment, the hydraulic grapple apparatus includes a support frame for attachment to a skid steer loader. The support frame has upper and lower guide tracks arranged in vertical alignment with each other and spaced apart in order to define an open channel therebetween. First and second grapple jaws are mounted on the upper and lower guide tracks for lateral movement along the support frame. First and second double-acting hydraulic cylinders are disposed in the open channel and coupled to the support frame. The first and second double-acting hydraulic cylinders independently actuate the first and second grapple jaws, respectively.

### TECHNICAL FIELD OF THE INVENTION

This invention relates, in general, to skid steer loaders and, in particular, to a hydraulic grapple apparatus that attaches to a skid steer loader and provides for gripping, lifting, transporting, and releasing large containers such as plastic containers containing nursery stock.

### BACKGROUND OF THE INVENTION

In gardening, and nursery work, it is very often necessary to rearrange large containers housing trees or other nursery stock within a nursery or tree farm prior to the time of sale when it becomes necessary to load the large containers onto trucks for delivery. Similarly, at the delivery site, the large nursery containers are moved from the delivery trucks to selected locations for planting. The combination of the irregular size and heavy weight of the large nursery containers posses the risk of back and muscle injuries to individuals or even teams of individuals that attempt to move or load the large nursery containers.

Therefore, the transportation of large nursery containers usually requires the utilization of a loading vehicle such as skid steer loader. The wide variety of work tools, such as pallet forks, utility buckets, and utility forks, for example, available for skid steer loaders have proven inadequate, however, for moving and loading large nursery containers. By way of example, pallet forks require the use of a pallet which may not be available or, if available, the pallet may not be properly pre-positioned under the large nursery container. By way of another example, utility forks often inadvertently pierce the large nursery containers with their prongs. The piercing and cracking of large nursery containers is particularly acute with respect to plastic containers. Accordingly, a need exists for improvements to work tools for skid steer loaders. In particular, a need exists for a work tool that provides for gripping, lifting, transporting, and releasing large nursery containers such as plastic containers.

### SUMMARY OF THE INVENTION

A hydraulic grapple apparatus and method for use of the same are disclosed that provide for the efficient and safe gripping, lifting, transporting, and releasing of large containers such as plastic nursery stock containers. In one embodiment, the hydraulic grapple apparatus includes a support frame for attachment to a skid steer loader. The support frame has upper and lower guide tracks arranged in vertical alignment with each other and spaced apart in order to define an open channel therebetween. First and second grapple jaws are mounted on the upper and lower guide tracks for lateral movement along the support frame. First and second double-acting hydraulic cylinders are disposed in the open channel and are coupled to the support frame. The first and second double-acting hydraulic cylinders independently actuate the first and second grapple jaws, respectively.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a front perspective view of one embodiment of a skid steer loader utilizing a hydraulic grapple apparatus in accordance with the teachings presented herein;

FIG. 2A is a top plan view of one embodiment of a hydraulic grapple apparatus preparing to grip a container having nursery stock;

FIG. 2B is a side view of the hydraulic grapple of FIG. 2A taken along line 2B-2B′;

FIG. 3A is a top view of the hydraulic grapple apparatus of FIG. 2A gripping and transporting the container;

FIG. 3B is a side view of the hydraulic grapple of FIG. 3A taken along line 3B-3B′;

FIG. 4A is a top view of the hydraulic grapple apparatus of FIG. 2A releasing the container;

FIG. 4B is a side view of the hydraulic grapple of FIG. 4A taken along line 4B-4B′;

FIG. 5A is a front perspective view of one embodiment of a grapple jaw traversing upper and lower guide tracks in accordance with the teachings presented herein;

FIG. 5B is a side view of the grapple jaw of FIG. 5A taken along line 5B-5B′;

FIG. 6 is a top plan view of another embodiment of a hydraulic grapple apparatus;

FIG. 7 is a front plan view of one embodiment of a hydraulic grapple apparatus wherein the grapple jaws are not illustrated in order to show double-acting hydraulic cylinders in further detail;

FIG. 8 is a schematic diagram of one embodiment of double-acting hydraulic cylinders coupled to a hydraulic system in order to actuate the grapple jaws; and

FIG. 9 is a side view of a presently preferred, exemplary embodiment of the hydraulic grapple apparatus.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

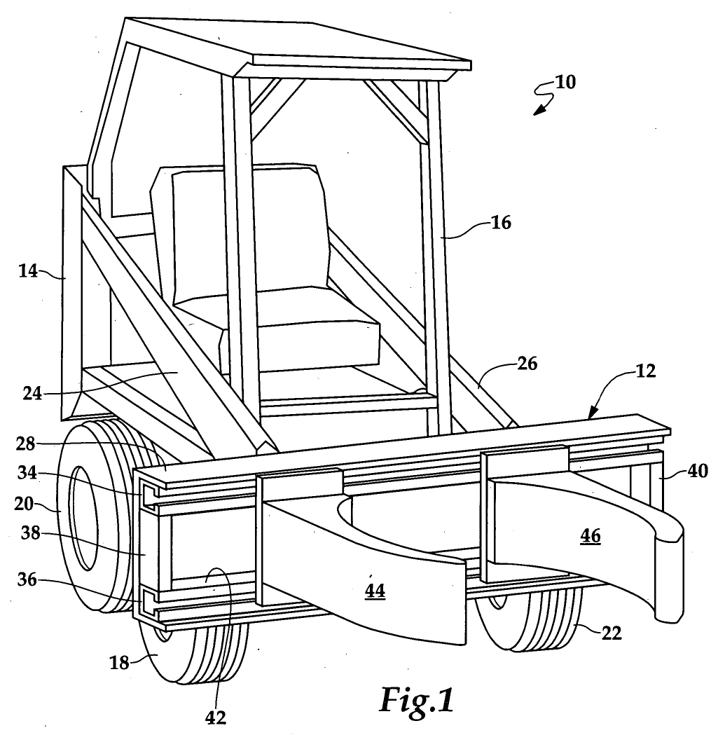

Referring initially to FIG. 1, therein is depicted one embodiment of a skid steer loader 10 utilizing a hydraulic grapple apparatus 12 in accordance with the teachings presented herein. The skid steer loader 10 includes a body 14 that houses the powertrain and drive system. In one implementation, the powertrain includes a diesel engine and a set of hydraulic pumps. The drive system may be a “no transmission” based system wherein a hydraulic motor and set of sprockets provide power to each wheel. A cage 16 forms a portion of the body 14 and provides a partially enclosed seating area that enables an operator to use controls positioned therein. Four wheels, including wheels 18, 20, and 22, provide maneuverability in tight spaces and permit the skid steer loader 10 to turn within its own footprint. It should be appreciated that the skid steer loader 10 may be outfitted with multi-terrain tracks instead of wheels to increase traction in slippery conditions like mud or snow and reduce soil compaction, for example.

Loader arms 24 and 26, which together define a hydraulic power lift, and their associated hydraulics are designed to hold a variety of implements and provide lifting capability. In one embodiment, the loader arms 24 and 26 lift the hydraulic grapple apparatus 12 in an arc such that as the hydraulic grapple apparatus 12 rises, it first moves out and away from the skid steer loader 10 before moving closer to the skid steer loader 10 as the hydraulic grapple apparatus 12 moves to a point higher than the skid steer loader. With this arrangement, the hydraulic grapple apparatus 12 sits close to the skid steer loader 10 in the down position to ensure that the skid steer loader 10 is more compact and stable. As the hydraulic grapple apparatus 12 is raised, it moves away from the skid steer loader 10 to provide more reach and make positioning cargo such as a container easier.

As illustrated, the hydraulic grapple apparatus 12 is attached to the skid steer loader 10. More specifically, the hydraulic grapple apparatus 12 includes a support frame 28 having brackets 30 and 32 for attachment to the loader arms 24 and 26, respectively. The support frame 28 also includes upper and lower, i.e., first and second, guide tracks 34 and 36 arranged in vertical alignment with each other and spaced apart by end blocks 38 and 40 such that an open channel 42 is defined between by the upper and lower guide tracks 34 and 36. The end blocks 38 and 40 aid in dispersing load and torque throughout the support frame 28.

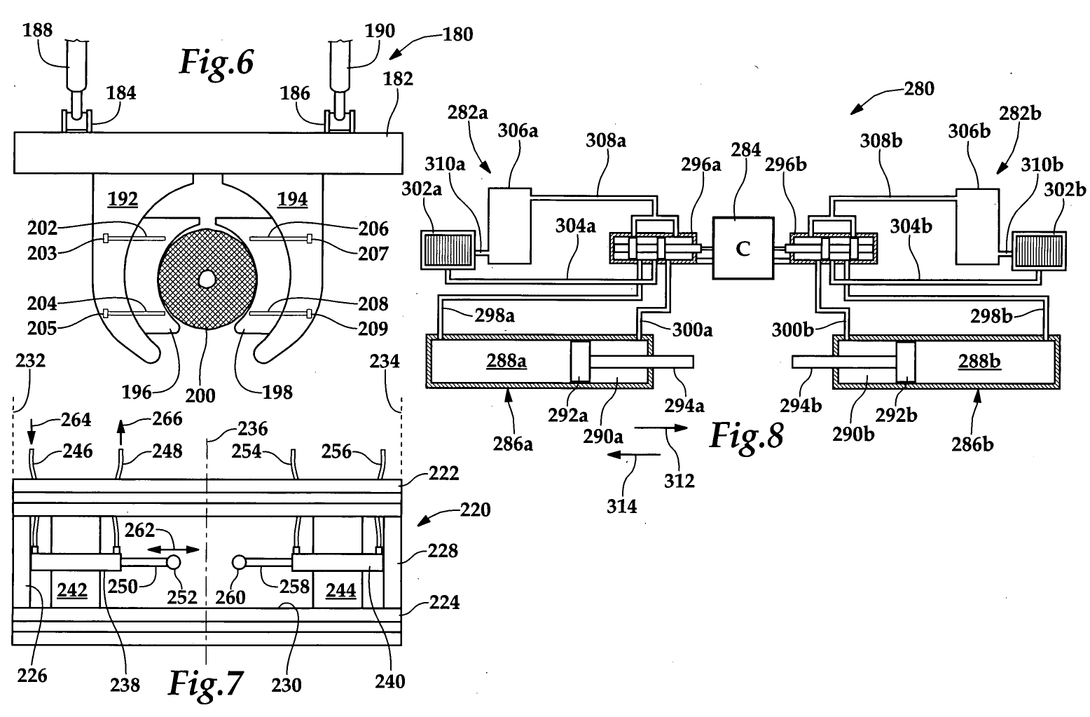

Grapple jaws 44 and 46 are mounted on the upper and lower guide tracks 34 and 36 for independent lateral movement along the support frame 28. The grapple jaws 44 and 46 are hydraulically actuated as will be discussed in further detail in FIG. 8. In one particular implementation that will be discussed in further detail in FIG. 7, double-acting hydraulic cylinders may be disposed in the open channel 42 and coupled to the support frame 28 or end blocks 38 and 40 in order to provide for the hydraulic actuation of the grapple jaws 44 and 46. According to this arrangement, the double acting hydraulic cylinders receive operating power from the hydraulic power system of the tractor, and the jaws can be extended and retracted independently of each other. This arrangement makes possible the precise positioning and gripping engagement of the grapple jaws around a container so that the container can be lifted, transported, and released without damaging the container. In particular, the precise positioning and gripping engagement enable the grappling of plastic containers without damaging the containers.

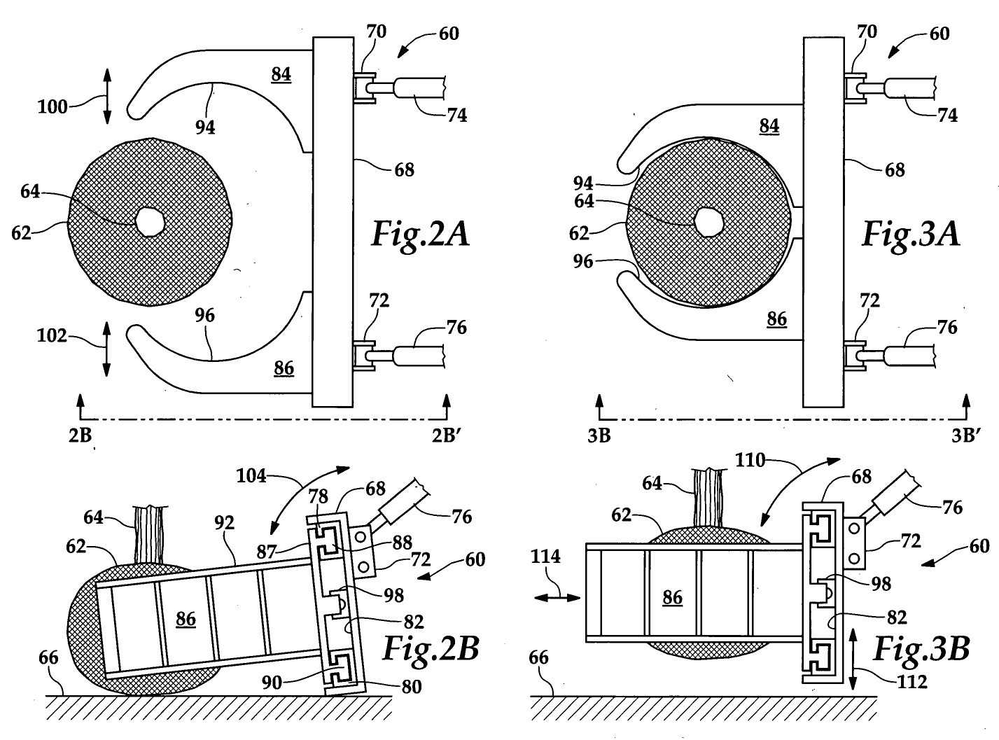

FIGS. 2A through 4B show the efficient and safe gripping, lifting, transporting, and releasing of large nursery stock by one embodiment of a hydraulic grapple apparatus 60. More specifically, FIGS. 2A and 2B depict the hydraulic grapple apparatus 60 preparing to grip a container 62 having large nursery stock, which is illustrated as a tree 64, that is resting on the ground as indicated by numeral 66. As depicted, the container 62 includes layers of tight burlap mesh that encapsulate the root system of the tree 64. It should be appreciated, however, that the hydraulic grapple apparatus presented herein may be utilized with other types of containers and cargo. In particular, the hydraulic grapple apparatus presented herein may be utilized with large plastic containers without breaking or cracking the plastic container.

The hydraulic grapple apparatus 60 includes a support frame 68 having brackets 70 and 72 for attachment to loader arms 74 and 76, respectively, of a skid steer loader. As an alternative to the bracket attachment system, a universal quick coupler may be employed to attach the hydraulic grapple apparatus 60 to the skid steer loader. Upper and lower guide tracks 78 and 80 are spaced apart such that an open channel 82 is defined therebetween. Grapple jaws 84 and 86 are mounted to the guide tracks 78 and 80. As illustrated with reference to grapple jaw 86, each grapple jaw includes a coupling plate having upper and lower support members 88 and 90 and jaw member 92 mounted thereto. Inner gripping surfaces 94 and 96 of grapple jaws 84 and 86, respectively, are positioned in an opposing relationship and shaped to generally conform to circular shaped containers and optimize the amount of surface area contact therebetween. In one embodiment, the components of the hydraulic grapple apparatus such as the support member, brackets, and grapple jaw, for example, are manufactured from metal and treated with a corrosion-resistant coating.

The grapple jaws 84 and 86 move under the power of double-acting hydraulic cylinders such as double-acting hydraulic cylinder 98 that is disposed in the open channel 82. As indicated by arrows 100 and 102, the grapple jaws 84 and 86 move in a mandibular motion toward each other to releasably grip the container 62. Once the grapple jaws are positioned proximate to the container 62, the grapple jaws 84 and 86 contact the container 62 and pull the container 62 towards the support frame 68. On the other hand, the grapple jaws 84 and 86 move in a mandibular motion away from each other in order to release the nursery container. As indicated by arrow 104, the loader arms permit the hydraulic grapple apparatus 60 to pivot which aids in not only picking up containers and cargo but placing containers and cargo as well.

FIGS. 3A and 3B depict the hydraulic grapple apparatus 60 gripping and transporting the container 62. The grapple jaws 84 have independently retracted toward a proximal local of the support member 68 and the container 62 is being held by the inner gripping surfaces 94 and 96 of the grapple jaws 84 and 86, respectively. The independently controlled movement of the grapple jaws 84 and 86 provides for precise placement of the grapple jaws with the appropriate use of gripping force, thereby ensuring that the container and its contents are not damaged. As indicated by arrows 110, 112, and 114, once the hydraulic grapple apparatus 60 grips the container 62, the container may be pivoted, lifted, or carried.

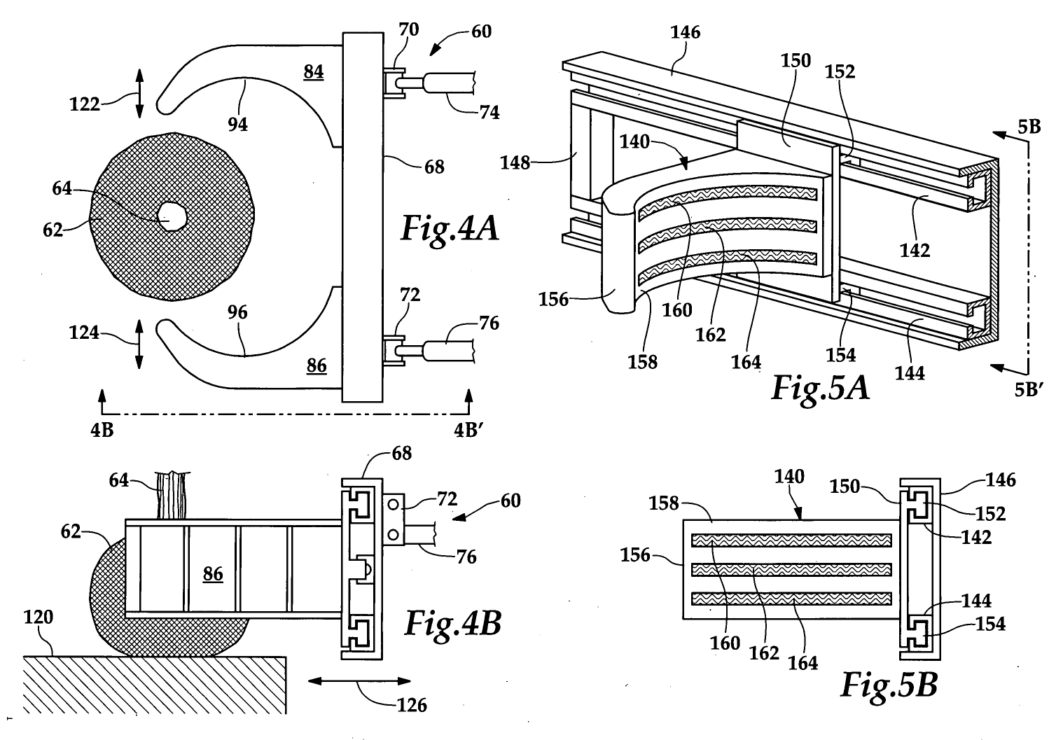

FIGS. 4A and 4B depict the hydraulic grapple apparatus 60 releasing the container 62 on a raised surface 120, which may be the bed of a delivery truck, for example. As indicated by arrows 122 and 124, once the container 62 is positioned over the desired destination, the grapple jaws 84 and 86 retract toward the distal ends of the support member 68, thereby releasing the container. It should be appreciated that the ability of the hydraulic grapple apparatus 60 to pivot as well as raise the container 62 permits the container 62 to be placed on a variety of surfaces of varying heights. Once the container 62 is released, the hydraulic grapple apparatus 60 withdraws under the power of the skid steer loader as indicated by arrow 126.

FIGS. 5A and 5B depict one embodiment of a grapple jaw 140 traversing partial upper and lower guide tracks 142 and 144 in accordance with the teachings presented herein. The portion of the upper and lower guide tracks 142 illustrated includes the upper and lower guide tracks from a distal end to a proximal local. A support frame 146 and an end block 148 maintain the positioning of the upper and lower guide tracks 142 and 144. It should be appreciated that the upper and lower guide tracks 142 and 144 may be lubricated or greased so that the grapple jaw 140 traverses the upper and lower guide tracks with minimum friction.

The grapple jaw 140 includes a coupling plate 150 having upper and lower support members 152 and 154 that correspond to the upper and lower guide tracks 142 and 144, respectively. A jaw member 156 is connected to the coupling plate such that an inner grip surface 158 faces the proximal local of the upper and lower guide tracks 142 and 144. Preferably, the coupling plate 150, upper support member 152, lower support member 154, and jaw member 156 form an integral grapple jaw 140. With arrangement described, the gripping jaws are coupled for sliding movement during extension and retraction in a sliding “tube within a tube” assembly along the lower and upper guide tracks. This parallel reaction coupling greatly increases the load that the gripping jaws can lift without imposing a damaging torque load on the support frame.

In one implementation, layers of grip tape 160, 162, and 164 are affixed to the inner grip surface 158 to improve the gripping ability of the grapple jaw 140. As previously discussed, in operation, the upper and lower support members traverse the upper and lower guide tracks, respectively to move the grapple jaw 140 toward the proximal local and the distal end.

FIG. 6 depicts another embodiment of a hydraulic grapple apparatus 180 which includes a support frame 182 having brackets 184 and 186 for attachment to loader arms 188 and 190, respectively. Grapple jaws 192 and 194 are mounted to and traverse guide tracks. As illustrated, the hydraulic grapple apparatus 180 is equipped with liners 196 and 198 in order to grip a small container 200. The liners 196 and 198 are coupled to the grapple jaws 192 and 194, respectively, by insert mounts 202, 204, 206, and 208 having pins which are received in holes 203, 205, 207, and 209, respectively, positioned in the grapple jaws 192 and 194. It should be appreciated by those skilled in the art that liners of different sizes may be utilized to accommodate containers of various sizes. Further, the shape of the liners does not necessarily have to correspond to the shape of the grapple jaws. Particular liners may be utilized to alter the shape of the inner grip surface of the grapple jaws to be correspond to the shape of the container.

FIG. 7 depicts one embodiment of a hydraulic grapple apparatus 220 wherein grapple jaws are not illustrated in order to show particular components in further detail. Upper and lower guide tracks 222 and 224 are vertically spaced apart from each other by end blocks 226 and 228 such that an open channel 230 is defined between the upper and lower guide tracks 222 and 224. Further, the upper and lower guide tracks 222 and 224 have distal ends as represented by dashed lines 232 and 234 and a proximal local as represented by dashed line 236.

Double-acting hydraulic cylinders 238 and 240 are disposed within the open channel 230 and coupled to the end blocks 226 and 228 as well as to the upper and lower guide tracks 222 and 224 by mounting braces 242 and 244. With respect to the double-acting hydraulic cylinder 238, hydraulic fluid hoses 246 and 248 provide for fluid communication between the double-acting hydraulic cylinder 238 and a hydraulic power system associated with the skid steer loader. The double-acting hydraulic cylinder 238 includes an arm 250 having a coupling member 252 for attaching a grapple jaw thereto. Similarly, the double-acting hydraulic cylinder 240 includes hydraulic fluid hoses 254 and 256, an arm 258, and a coupling member 260.

With reference to the double-acting hydraulic cylinder 238, the hydraulic fluid hoses 246 and 248 are used to vary the application of forward and backward pressure to a piston housed therein. As indicated by arrow 262, the changes in pressure extend the arm 250 and grapple jaw toward the proximal local 236 of the upper and lower guide tracks or retract the arm and the grapple jaw toward the distal end 232. As indicated by arrows 264 and 266, when hydraulic fluid flow is increased to a rear chamber within the double-acting hydraulic cylinder 238, hydraulic fluid exits the double-acting hydraulic cylinder 238 through hose 248 as the arm 250 extends towards the distal local 236. It should be appreciated that the orientation of the double-acting hydraulic cylinder may be reversed such that the arm and grapple jaw are retracted toward the proximal local or the arm and the grapple jaw are extended toward the distal end.

FIG. 8 depicts one embodiment of a hydraulic system 280 that actuates grapple jaws associated with a skid steer loader. As depicted, the hydraulic system 280 includes two halves 282a and 282b under the control of a controller 284. For purposes of illustration, the hydraulic system half 282a will be described. It should be appreciated, however, that the operation of the hydraulic system half 282b is similar to the operation of hydraulic system half 282a. Further, the components of the hydraulic system half 282a are designated by the inclusion in their numeral of the letter “a” while the corresponding components of the hydraulic system half 282b are designated by the inclusion of the letter “b”.

A double-acting hydraulic cylinder 286a includes chambers 288a and 290a which are partitioned by a piston 292a. An arm 294a is coupled to the piston 292a and a grapple jaw may be coupled to the arm as previously described. A spool valve 296a is coupled to the chambers 288a and 290a by fluid control lines 298a and 300a, respectively. A pump 302a is in fluid communication with the spool valve 296a via fluid control line 304a. A hydraulic fluid reservoir 306a is in fluid communication with the spool valve 296a and the pump 302a by way of fluid control lines 308a and 310a, respectively. In one implementation, all of the illustrated components except for the double-acting hydraulic cylinders 286a and 286b form a portion of a hydraulic system that is associated with the skid steer loader. In this implementation, these components of the hydraulic system are connected to the double-acting hydraulic cylinders by the fluid control lines 298a, 298b, 300a, and 300b.

In operation, when the operator of the skid steer loader desires to move the grapple jaw associated with the arm 294a toward a container or object, the operator uses the controller 284 to signal the spool valve 296a to apply forward pressure to the piston 292a. In one embodiment, the controller may include two joysticks and associated electronics and hydraulics. During this operation, hydraulic fluid flow is increased to chamber 288a, thereby increasing the pressure in the chamber 288a and causing the piston 292a and arm 294a to extend in the direction indicated by arrow 312. Further, this extension displaces fluid from the chamber 300a.

On the other hand, when the operator of the skid steer loader desires to move the grapple jaw associated with the arm 294a away from the container, hydraulic fluid flow is increased to chamber 290a, thereby increasing the pressure in the chamber 290a and causing the piston 292a and arm 294a to retract in the direction indicated by arrow 314, thereby displacing fluid from the chamber 288a. As previously discussed, controller 284 provides for the independent actuation of the grapple jaws. Therefore, nine operations are possible with respect to arms 290a and 290b and their respective grapple jaws. Table I summarizes these possible operations.

TABLE I
Arm Operations

| Operation | Arm 294a | Arm 294b |
|---|---|---|
| One | stationary | stationary |
| Two | stationary | extending |
| Three | stationary | retracting |
| Four | extending | stationary |
| Five | extending | extending |
| Six | extending | retracting |
| Seven | retracting | stationary |
| Eight | retracting | extending |
| Nine | retracting | retracting |

The variety of arm operations ensure precise handling and control of the grapple jaws and the container or cargo. In particular, the grapple jaws enable the handling of large plastic containers without damaging or harming both the container and the nursery stock within the container. Further, the parallel actuation of the grapple jaws greatly increases the load that the skid steer loader can lift without imposing a damaging torque load on the support frame.

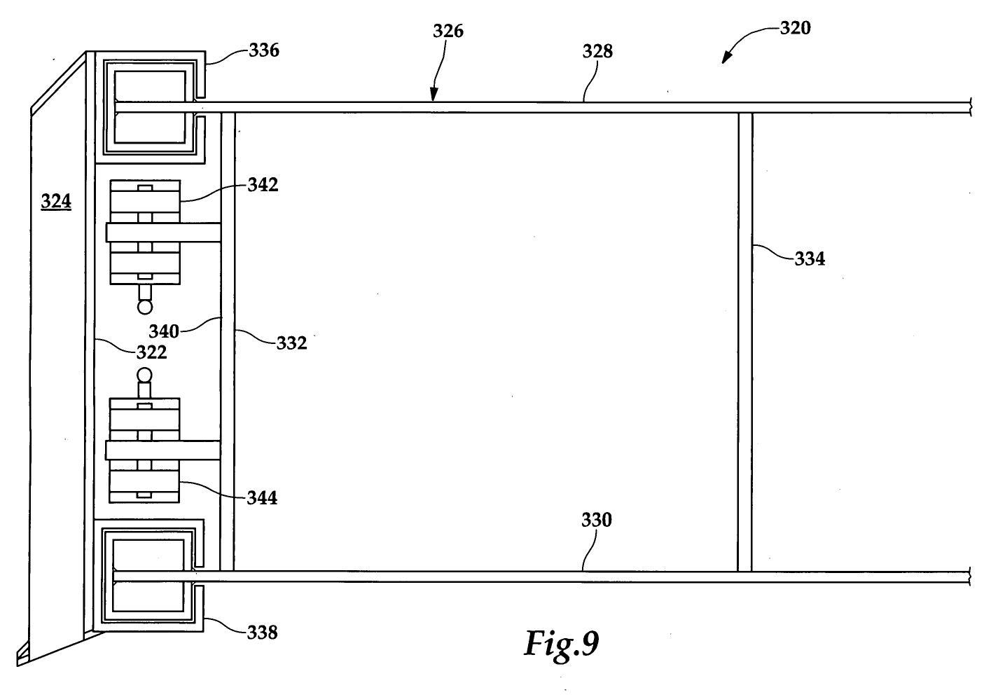

FIG. 9 depicts a presently preferred, exemplary embodiment of the hydraulic grapple apparatus 320 that includes a support frame 322 for attachment to skid loader mounting bracket 324 of a skid steer loader. A grapple jaw, which is partially shown, includes a support structure 326 having lower plates 328, 330 as well as a backing plate 332 and an upright plate 334. It should be appreciated that a second structural support provides a frame for the other grapple jaw. The upper and lower plates 328, 330 are positioned within guide tracks 336 and 338, respectively, which are coupled to the support frame 322 and arranged in vertical alignment and spaced apart to define an open channel 340. Double-acting hydraulic cylinders 342 and 344 are positioned within the channel 340 and coupled to the backing plate 332. As previously discussed, the double-acting hydraulic cylinders 342 and 344 actuate the grapple jaws.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A hydraulic grapple apparatus comprising:
a support frame for attachment to a skid steer loader, the support frame including first and second guide tracks arranged in vertical alignment with each other and spaced apart to define an open channel therebetween;
first and second grapple jaws mounted on the first and second guide tracks for lateral movement along the support frame; and
first and second double-acting hydraulic cylinders disposed in the open channel and coupled to the support frame, the first and second double-acting hydraulic cylinders for actuating the first and second grapple jaws, respectively.

2. The hydraulic grapple apparatus as recited in claim 1, wherein the support frame is attached to a hydraulic power lift of the skid steer loader.

3. The hydraulic grapple apparatus as recited in claim 1, further comprising first and second end blocks coupled to the support frame and positioned within the open channel.

4. The hydraulic grapple apparatus as recited in claim 3, wherein the first and second double-acting hydraulic cylinders are attached to the first and second end blocks, respectively.

5. The hydraulic grapple apparatus as recited in claim 1, wherein the first and second double-acting hydraulic cylinders independently actuate the first and second grapple jaws.

6. The hydraulic grapple apparatus as recited in claim 1, wherein the first and second double-acting hydraulic cylinders are coupled to a hydraulic system associated with the skid steer loader.

7. The hydraulic grapple apparatus as recited in claim 1, wherein the first and second grapple jaws releasably grip a container.

8. The hydraulic grapple apparatus as recited in claim 1, wherein the first and second grapple jaws releasably grip growing nursery stock housed within a plastic container.

9. A hydraulic grapple apparatus comprising:
a support frame for attachment to a skid steer loader having a hydraulic power system, the support frame including first and second guide tracks arranged in vertical alignment with each other and spaced apart to define an open channel therebetween; and
first and second grapple jaws mounted on the first and second guide tracks for independently transversing the first and second guide tracks, the first and second grapple jaws being in fluid communication with the hydraulic power system.

10. The hydraulic grapple apparatus as recited in claim 9, wherein the support frame is attached to a hydraulic power lift of the skid steer loader.

11. The hydraulic grapple apparatus as recited in claim 9, wherein the support frame further comprises a universal quick coupler that is utilized to attach the support frame to the skid steer loader.

12. The hydraulic grapple apparatus as recited in claim 9, wherein the first and second grapple jaws releasably grip a container.

13. A method for handling containers, the method comprising:
positioning a skid steer loader having a hydraulic grapple apparatus proximate to the container, the hydraulic grapple apparatus including a support frame having first and second guide tracks arranged in vertical alignment;
providing hydraulic power to first and second grapple jaws, the first and second grapple jaws being mounted on the first and second guide tracks; and
independently actuating the first and second grapple jaws to releasably grip the container.

14. The method as recited in claim 13, further comprising actuating a hydraulic power lift to lift the hydraulic grapple apparatus, thereby lifting the container.

15. The method as recited in claim 13, further comprising actuating a hydraulic power lift to pivot the hydraulic grapple apparatus, thereby pivoting the container.

16. The method as recited in claim 13, further comprising driving the skid steer loader, thereby transporting the container.

17. The method as recited in claim 13, further comprising independently actuating the first and second grapple jaws to release the container.

18. A skid steer loader comprising:
a body having a hydraulic power system;
a hydraulic grapple apparatus attached to the body, the hydraulic grapple apparatus including a support frame having first and second guide tracks arranged in vertical alignment;
means for providing hydraulic power to first and second grapple jaws, the first and second grapple jaws being mounted on the first and second guide tracks; and
means for independently actuating the first and second grapple jaws to releasably grip the container.

19. The skid steer loader as recited in claim 18, wherein the container comprises growing nursery stock.

20. The skid steer loader as recited in claim 18, wherein the means for providing hydraulic power to the first and second grapple jaws further comprises first and second double-acting hydraulic cylinders.
